(19) United States
(12) Patent Application Publication
(10) Pub. No.: US 2023/0175527 A1
(43) Pub. Date: Jun. 8, 2023

(54) TURBOMACHINE COMPRESSOR HAVING A STATIONARY WALL PROVIDED WITH A SHAPE TREATMENT

(71) Applicant: SAFRAN HELICOPTER ENGINES, Bordes (FR)

(72) Inventors: Fabien Jean-Michel ARTUS, Moissy-Cramayel (FR); Laurent Pierre TARNOWSKI, Moissy-Cramayel (FR)

(21) Appl. No.: 17/997,955

(22) PCT Filed: Apr. 23, 2021
(86) PCT No.: PCT/FR2021/050704

§ 371 Date: Nov. 4, 2022

(30) Foreign Application Priority Data
May 6, 2020 (FR) 2004496

(51) Int. Cl. F04D 29/56; F01D 17/16; F04D 29/68

(52) U.S. Cl. CPC F04D 29/563; F01D 17/16; F04D 29/681; F05D 2220/32; F05D 2240/12; F05D 2260/60

(57) ABSTRACT

A turbomachine includes a compressor including variable-pitch stationary vanes each extending radially between a rotary hub and a stationary casing surrounding this rotary hub, each variable-pitch vane including a blade having a base spaced apart by a first radial gap from a stationary wall of the casing, and a tip spaced apart by a second radial gap from a rotary wall of the rotary hub. The stationary wall of the casing or the rotary wall of the rotary hub includes at the blade a shape treatment arranged to channel an air leak passing through the corresponding gap.

### TECHNICAL FIELD

The invention relates to a stator element of a turbomachine including variable-pitch stationary vanes equipping a compressor of this turbomachine, this compressor optionally being axial or centrifugal, the invention applying both to an aircraft engine type turbomachine and to a helicopter turbine type turbomachine.

### PRIOR ART

As a general rule, a turbomachine compressor includes a rotor rotating about a main axis, which bears several stages of mobile blades spaced apart from one another along this axis, and a rotational stationary casing surrounding the assembly which is traversed from upstream to downstream by an air flow when the assembly is in operation. The assembly is traversed by an air flow circulating in an annular space delimited internally by the rotor and externally by the casing.

Between two consecutive mobile stages a stage of stationary blades, known as a stator, is inserted, for channelling the air longitudinally to untwist it before it enters the next mobile stage. Such a stator is in the form of a stationary bladed disk borne by the casing surrounding the rotor locally.

The blades of one or more of these stationary stages are advantageously variable-pitch, so that the angular position thereof around a radial or inclined axis can be adjusted in order to adapt it to the operating conditions of the turbomachine which fluctuate during the use thereof.

These variable-pitch stationary blades are controlled by control elements dynamically adjusting the pitch thereof. As a general rule, they make it possible to adapt the fluid flow before admission into the mobile stage immediately following them, to extend the range of the operating conditions wherein the compressor can be used without an aerodynamic stalling risk.

In the event of aerodynamic stalling, a fluid plug is formed, referred to as surge, which opposes the air circulation in the compressor. Such a situation can give rise to the rupture of vanes of the compressor, i.e. damage or destroy the compressor. To this end, discharge valves can be provided to open in order to decompress the air present in the compressor, in certain circumstances, to prevent the establishment of surge, i.e.

aerodynamic stalling, conditions.

Nevertheless, aerodynamic stalling represents a key factor which limits the extent of the range of the conditions of use of the compressor, such that it represents an important element in the design and dimensioning of a compressor. The aim of the invention is that of providing a solution for limiting the aerodynamic stalling risk in a compressor including a stator bearing variable-pitch blades.

### DESCRIPTION OF THE INVENTION

To this end, the invention relates to a compressor comprising a stationary casing bearing variable-pitch stationary vanes each extending radially from this stationary casing to a rotary hub surrounded by this stationary casing, each variable-pitch vane comprising a blade having a base spaced apart by a radial gap from a stationary wall of the casing, and wherein the stationary wall of the compressor includes at the bases of the blades a shape treatment arranged to channel an air leak passing through the gap.

With this solution, the air flow traversing the gaps at the blade base is rectified to the axial direction, such that the flow is untwisted more effectively, which limits the risk of aerodynamic stalling of the compressor. This consequently makes it possible to extend the range of operating conditions in which the compressor can be used, i.e. the operability of the compressor.

The invention also relates to a compressor thus defined, wherein each blade includes a tip spaced apart by another radial gap from a rotary wall of the rotary hub, and wherein the rotary wall includes at the tips of the blades a shape treatment arranged to channel an air leak passing through this other gap.

The invention also relates to a compressor thus defined, wherein the stationary wall includes a shape treatment comprising grooves, these grooves being open towards the blade bases along the entire length thereof.

The invention also relates to a compressor thus defined, wherein the rotary wall includes a shape treatment comprising grooves, these grooves being open towards the blade tips along the entire length thereof.

The invention also relates to a turbomachine comprising a compressor thus defined.

### BRIEF DESCRIPTION OF THE DRAWINGS

FIG. 1 is a schematic sectional view of a compressor portion according to the invention;

FIG. 2 is a schematic view of a variable-pitch stationary vane of a compressor according to the invention;

FIG. 3 is a schematic view showing axial grooves formed on a stationary wall of the compressor according to the invention;

FIG. 4 is a schematic view showing circumferential grooves formed on a rotary wall of the compressor according to the invention.

### DETAILED DESCRIPTION OF THE INVENTION

The invention is based on the observation whereby the presence of leakage flows in the compressor induces a risk of aerodynamic stalling, such that the reduction in certain leakage flow rates makes it possible to limit the aerodynamic stalling risk, i.e. increase the extent of the range of conditions of use of the compressor.

More concretely, the invention makes it possible to reduce the risk of aerodynamic stalling by limiting the leakage flows existing at the tip and/or base of the variable-pitch stationary blades of the compressor.

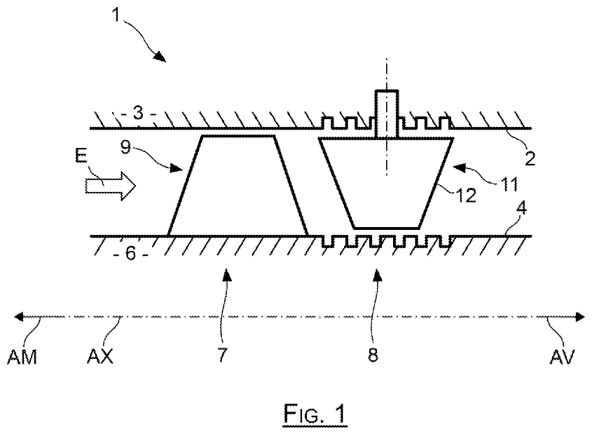

In FIG. 1, a turbomachine compressor portion 1 is traversed by a fluid flowing along a longitudinal axis AX of the turbomachine from upstream AM to downstream AV. This compressor portion 1 is here delimited externally by a stationary wall 2 of a generally rotational stationary casing 3, and internally by a rotary wall 4 of a rotor hub 6, this inner wall being generally rotational and coaxial with the longitudinal axis AX.

This compressor portion 1 includes here a rotary stage 7, followed immediately downstream AV thereof by a stationary stage 8. The rotary stage comprises rotary vanes borne by the hub rotating about the axis AX, one of these rotary vanes can be seen in FIG. 1 where it is referenced 9. The stationary stage 8 bears stationary vanes, one of these stationary vanes can be seen in the figure where it is referenced 11.

Each stationary vane 11 of the stage 8 is a variable-pitch vane, comprising a blade 12 borne by a root 13 which is held by the casing 3, being capable of rotating about a radial axis AR that can be inclined or oblique with respect to the axis AX. The blade 12 includes a base 14 located facing the stationary wall 2, extended by a blade body 16 ending with a tip 17 located facing the rotary wall 4, i.e. the wall of the rotary hub 6.

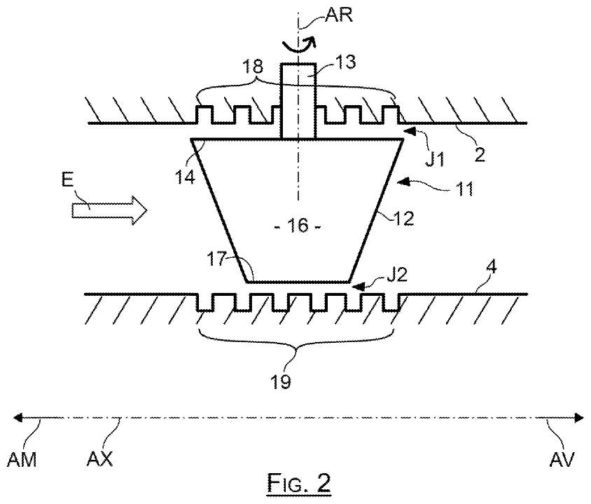

As seen in FIG. 2, there is, on one hand, a first radial gap J1 between the base 14 and the stationary wall 2, and similarly there is a second radial gap J2 between the tip 17 which is stationary and the rotary wall 4.

These gaps result from mounting and thermal expansion stress arising in the turbomachine in operation, such that it is not possible to remove them. In operation, air to be rectified by the stationary stage 8 leaks by passing through the void formed by the first gap J1 and through the void forms by the second gap J2. This air circulates from the lower surface side of the variable-pitch stationary vane to the upper surface side thereof, along the stationary wall 2 and the rotary wall 4.

As a general rule, these leakage flows give rise to a deviation of the fluid flow passing through the stationary stage, which penalises the untwisting effect of this stationary stage. In concrete terms, the fact that the fluid is not untwisted sufficiently results in a risk of aerodynamic stalling of the compressor.

In other words, these leaks limit the operability of the compressor, i.e. the extent of the range of the operating conditions wherein the compressor can be used without an aerodynamic stalling risk.

According to the invention, the stationary wall 2 of the casing includes a shape treatment, referenced 18 in FIG. 2, in the region of the vane 11, intended to limit the disturbance introduced into the main flow E by the fluid leaking through the gap J1. This shape treatment is aimed at correcting the direction of flow of the flow leaking through the gap to restore it to parallel with the longitudinal axis.

This shape treatment is materialised for example by grooves formed on the inner face of the wall 2, these grooves being arranged to rectify the fluid flowing through the gap .11, from the lower surface side to the upper surface side of the blade.

Thanks to this shape treatment, the fluid passing through the gap J1 is reintroduced into the main flow E having at the outlet of this gap J1 the closest possible orientation to that of the fluid of the main flow E along the upper surface at the base 14 of the blade.

Advantageously, the rotary wall 4 of the hub also includes a shape treatment, referenced 19, which is located at the blade tip 17, so as to reduce the disturbance introduced into the main flow E by the fluid leaking through the second gap J2.

As a general rule, the grooves are oriented to promote a guidance of the leakage flow in an axial direction, so as to promote the untwisting of the flow including in the leakage zones.

As a general rule, the orientation of the grooves is dependent on the case in question, and on the design of the compressor. These grooves are generally rectilinear, having either a relatively similar orientation to that of the axis in the case of longitudinal or axial grooves, or a similar orientation to the normal to the longitudinal axis to form circumferential or helical grooves.

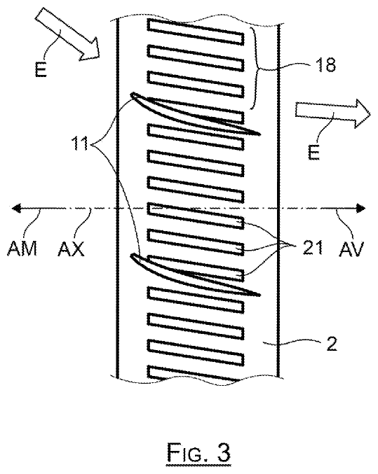

In the example in FIG. 3, the stationary wall 2 of the casing includes axial grooves 21, having a small angle with respect to the axis AX to help rectify the leakage flow through the gap J1 towards the longitudinal direction, the wall 2 of the casing being a stationary wall.

These grooves 21 cover a length, along the axis AX, which is less than the length of the blades along the axial direction multiplied by 1.2, and they form an angle with the axial direction AX between +45° and −45°.

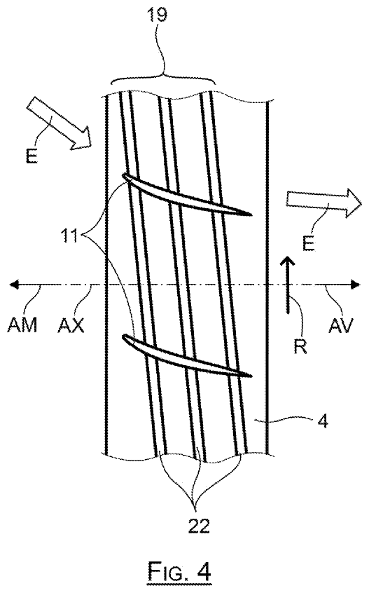

In the example in FIG. 4, the grooves 22 equipping the rotary wall 4 of the hub are of the helical type having a similar orientation to the perpendicularity to the axis AX. These grooves thus form helicoids in the manner of an endless screw which advances from upstream to downstream when the hub rotates, so as to rectify the leakage flow through the gap J2 in the axial direction AX.

These grooves 22 are disposed side by side extending as a whole along a length less than the length of the blades along the axial direction multiplied by 1.2, and they form an angle with the normal to the axial direction AX between +45° and −45°.

The examples of grooves represented in FIGS. 3 and 4 are given merely as an indication, the grooves being capable more generally of having any shape adapted to the case in question, these grooves being capable in particular of being curved instead of rectilinear. In particular, axial grooves of the type represented in FIG. 3 can be provided on a rotary wall, and helical grooves of the type represented in FIG. 4 can be provided on a stationary wall.

What is claimed is:

1. Compressor comprising a stationary casing bearing variable-pitch stationary vanes each extending radially from this stationary casing to a rotary hub surrounded by this stationary casing , each variable-pitch vane comprising a blade having a base spaced apart by a radial gap from a stationary wall of the casing, and wherein the stationary wall of the compressor includes at the bases of the blades a shape treatment arranged to channel an air leak passing through the gap.

2. Compressor according to claim 1, wherein each blade includes a tip spaced apart by another radial gap from a rotary wall of the rotary hub, and wherein the rotary wall includes at the tips of the blades a shape treatment OM-arranged to channel an air leak passing through this other gap.

3. Compressor according to claim 1, wherein the stationary wall includes a shape treatment comprising axial and circumferential grooves , these grooves being open towards the bases of blades along the entire lengths thereof.

4. Compressor according to claim 2, wherein the rotary wall includes a shape treatment OM-comprising axial or circumferential grooves, these grooves being open towards the tips of blades along the entire lengths thereof.

5. Turbomachine comprising a compressor according to claim 1.

6. Turbomachine comprising a compressor according to claim 1 including axial grooves and circumferential grooves.
